(19) United States
(12) Patent Application Publication
(10) Pub. No.: US 2026/0284923 A1
(43) Pub. Date: Sep. 24, 2026

(54) ALIGNMENT TOOL FOR ALIGNING CUTTING COMPONENTS IN A FIBROUS GLASS BOARD DUCT CUTTING APPARATUS, A FIBROUS GLASS BOARD DUCT CUTTING SYSTEM, AND A METHOD OF USING THE SAME

(71) Applicant: Certainteed LLC, Malvern, PA (US)

(72) Inventors: Jason E. ST. JOHN, Valrico, FL (US); Bruce A. Hartzell, Mickleton, NJ (US); Juan C. Miranda, Lakeland, FL (US); James A. McKenzie, Winter Haven, FL (US)

(21) Appl. No.: 19/040,915

(22) Filed: Jan. 30, 2025

Related U.S. Application Data
(60) Provisional application No. 63/549,117, filed on Feb. 2, 2024.

(51) Int. Cl. B26D 7/28; B26D 7/01

(52) U.S. Cl. CPC B26D 7/28; B26D 7/015

(57) ABSTRACT

The present disclosure relates to an alignment tool for aligning cutting components of a fibrous glass board duct cutting apparatus may include a base component, and a top component. The top component may be slidably mounted to the base component and configured so that a first adjustable spacing dimension is created between an outer edge of the first base spacer feature and an outer edge of the first top spacer feature.

### CROSS-REFERENCE TO RELATED APPLICATION(S)

This Application claims priority under 35 U.S.C. §119(e) to U.S. Provisional Patent Application No. 63/549,117, entitled “ALIGNMENT TOOL FOR ALIGNING CUTTING COMPONENTS IN A FIBROUS GLASS BOARD DUCT CUTTING APPARATUS, A FIBROUS GLASS BOARD DUCT CUTTING SYSTEM, AND A METHOD OF USING THE SAME,” by Jason E. ST. JOHN et al., filed Feb. 2, 2024, which is assigned to the current assignee hereof and is incorporated herein by reference in its entirety.

### FIELD OF THE DISCLOSURE

The present disclosure relates generally to tools for fibrous glass board duct cutting systems, for example, a fibrous glass board duct cutting apparatus that includes multiple cutting components and an alignment tool for aligning the cutting components for cutting grooves into fibrous glass board such that it is configured to form ducts. The present disclosure relates more particularly to an alignment tool for aligning the cutting components of the fibrous glass board duct cutting apparatus.

### BACKGROUND

Insulated ducts may be formed from fibrous glass board material. To form the ducts, grooves are cut into the fibrous glass board material at set distances or spacing so that the material may be formed (i.e., folded) into the desired duct shape. The grooves are cut with uniform spacing that corresponds to desired dimensions of each side of the duct. Since ducts of many sizes and dimensions are desired, machines that are used for cutting grooves into the fibrous glass board material must include the ability to adjust the spacing between the machine's groove-cutting tools. For this reason, an alignment tool for accurately and uniformly spacing the groove-cutting tools of such a machine at various dimensions is desirable.

### SUMMARY

According to a first aspect, an alignment tool for aligning cutting components of a fibrous glass board duct cutting apparatus may include a base component, and a top component. The base component may have a top surface, a bottom surface opposite of the top surface, a first longitudinal edge, a second longitudinal edge opposite of the first longitudinal edge, a front edge, a back edge opposite of the front edge, and a first base spacer feature extending out from the first longitudinal edge of the base component at the front edge of the base component. The top component may have a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component. The top component may be slidably mounted to the base component and configured so that a first adjustable spacing dimension is created between an outer edge of the first base spacer feature and an outer edge of the first top spacer feature.

According to another aspect, a fibrous glass board duct cutting system may include a fibrous glass board duct cutting apparatus, and an alignment tool. The fibrous glass board duct cutting apparatus may include a base, a mounting component, and a plurality of fibrous glass board cutting components attached to the mounting component. The alignment tool may include a base component and a top component. The base component may have a top surface, a bottom surface opposite of the top surface, a first longitudinal edge, a second longitudinal edge opposite of the first longitudinal edge, a front edge, a back edge opposite of the front edge, and a first base spacer feature extending out from the first longitudinal edge of the base component at the front edge of the base component. The top component may have a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component. The top component may be slidably mounted to the base component and configured so that a first adjustable spacing dimension is created between an outer edge of the first base spacer feature and an outer edge of the first top spacer feature. The spacing dimension may be configured to uniformly space the plurality of fibrous glass board cutting components along the mounting component of the fibrous glass board duct cutting apparatus.

According to still another aspect, a method of configuring a fibrous glass board duct cutting system may include providing a fibrous glass board duct cutting apparatus that includes a base, a mounting component, and a plurality of fibrous glass board cutting components attached to the mounting component, and using an alignment tool to uniformly space the plurality of fibrous glass board cutting components along the mounting component of the fibrous glass board groove-cutting apparatus. The alignment tool may include a base component and a top component. The base component may have a top surface, a bottom surface opposite of the top surface, a first longitudinal edge, a second longitudinal edge opposite of the first longitudinal edge, a front edge, a back edge opposite of the front edge, and a first base spacer feature extending out from the first longitudinal edge of the base component at the front edge of the base component. The top component may have a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component. The top component may be slidably mounted to the base component and configured so that a first adjustable spacing dimension is created between an outer edge of the first base spacer feature and an outer edge of the first top spacer feature. The spacing dimension may be configured to uniformly space the plurality of fibrous glass board cutting components along the mounting component of the fibrous glass board duct cutting apparatus.

According to yet another aspect, a method of forming a fibrous glass board duct may include providing a fibrous glass board duct cutting system that may include a fibrous glass board duct cutting apparatus, and an alignment tool, providing a piece of uncut fibrous glass board material, using the alignment tool to configure the fibrous glass board duct cutting apparatus for cutting grooves into the uncut fibrous glass board material, cutting grooves into the piece of uncut fibrous glass board using the configured fibrous glass board cutting apparatus, and forming the cut piece of fibrous glass board in the fibrous glass board duct. The fibrous glass board duct cutting apparatus may include a base, a mounting component, and a plurality of fibrous glass board cutting components attached to the mounting component. The alignment tool may include a base component and a top component. The base component may have a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component. The top component may have a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component. The top component may be slidably mounted to the base component and configured so that a first adjustable spacing dimension is created between an outer edge of the first base spacer feature and an outer edge of the first top spacer feature. The spacing dimension may be configured to uniformly space the plurality of fibrous glass board cutting components along the mounting component of the fibrous glass board duct cutting apparatus. Using the alignment tool to configure the fibrous glass board duct cutting apparatus may include using the alignment tool to uniformly space the plurality of fibrous glass board cutting components along the mounting component of the fibrous glass board groove-cutting apparatus.

### BRIEF DESCRIPTION OF THE DRAWINGS

Embodiments are illustrated by way of example and are not limited to the accompanying figures.

FIG. 1A includes an illustration of a first schematic perspective view of an alignment tool according to an embodiment described herein;

FIG. 1B includes an illustration of a second schematic perspective view of the alignment tool of FIG. 1A according to an embodiment described herein;

FIG. 1C includes an illustration of a schematic side-view of the alignment tool of FIG. 1A according to an embodiment described herein;

FIG. 2A includes an illustration of a first schematic view of an alignment tool according to an alternative embodiment described herein;

FIG. 2B includes an illustration of a second schematic perspective view of the alignment tool of FIG. 2A according to an embodiment described herein;

FIG. 2C includes an illustration of a third schematic perspective view of the alignment tool of FIG. 2A according to an embodiment described herein;

FIG. 2D includes an illustration of a fourth schematic perspective view of the alignment tool of FIG. 2A according to an embodiment described herein; and

FIG. 3 is a schematic perspective view of a fibrous glass board duct cutting system according to an embodiment described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to an alignment tool for aligning cutting components of a fibrous glass board duct cutting apparatus.

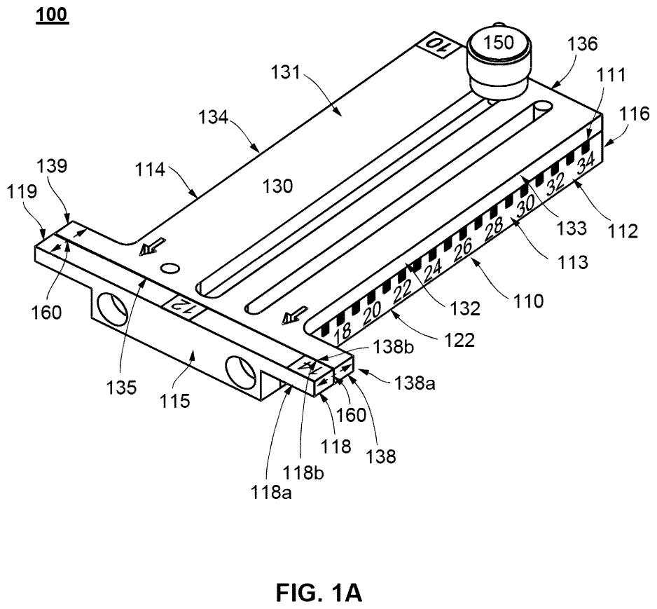

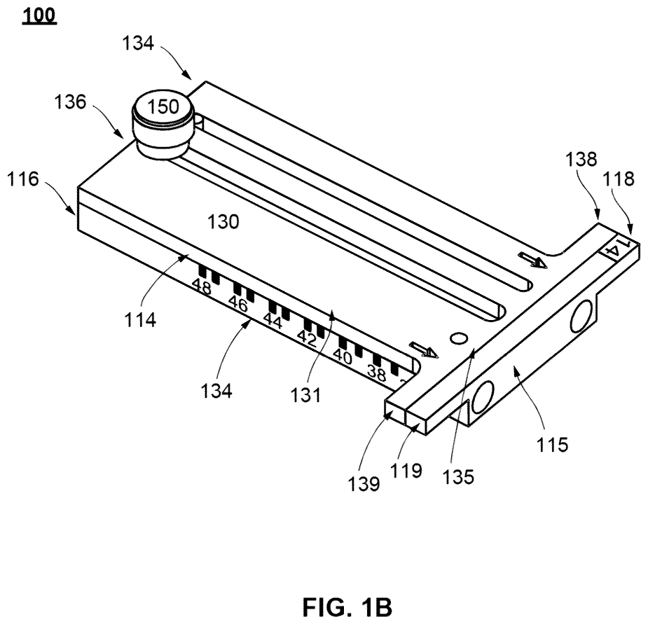

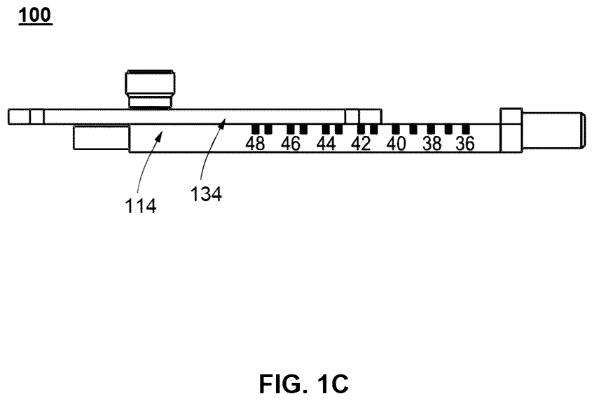

For purposes of illustration, FIGS. 1A, 1B, and 1C show various schematic views of an alignment tool 100 according to embodiments described herein.

FIG. 1A shows a schematic perspective view of the alignment tool 100 according to embodiments described herein. As shown in FIG. 1A, the alignment tool 100 may include a base component 110, and a top component 130.

According to certain embodiments, and as shown in FIG. 1A, the base component 110 may have a top surface 111, a bottom surface 112, a first longitudinal edge 113, a second longitudinal edge 114, a front edge 115, a back edge 116, a first base spacer feature 118, and a second base spacer feature 119.

According to still other embodiments, and as shown in FIG. 1A, the top component 130 may have a top surface 131, a bottom surface 132 opposite of the top surface 131, a first longitudinal edge 133, a second longitudinal edge 134 opposite of the first longitudinal edge 133, a front edge 135, a back edge 136 opposite of the front edge 135, a first top spacer feature 138, and a second base spacer feature 139.

According to yet other embodiments, the first base spacer feature 118 may extend out from the first longitudinal edge 113 of the base component 110. According to certain embodiments, the first base spacer feature 118 may extend out from the first longitudinal edge 113 at any desired location. According to yet other embodiments, the first base spacer feature 118 may extend out from the first longitudinal edge 113 at the front edge 115.

According to still other embodiments, the first top spacer feature 138 may extend out from the first longitudinal edge 133 of the top component 130. According to certain embodiments, the first top spacer feature 138 may extend out from the first longitudinal edge 133 at any desired location. According to yet other embodiments, the first top spacer feature 138 may extend out from the first longitudinal edge 133 at the front edge 135.

According to certain embodiments, the top component 130 may be slidably mounted to the base component 110. According to particular embodiments, the top component 130 may be slidably mounted to the base component 110 so that the top component 130 can move longitudinally along the top surface 111 of the base component 110. It will be appreciated that the top component 130 may be slidably mounted to the base component 110 using any means that will allow for the longitudinal movement of the top component 130 along the bottom component 110.

According to yet other embodiments, the top component 130 and the base component 110 may be configured so that a first adjustable spacing dimension 160 is created between an outer edge 118a of the first base spacer feature 118 and an outer edge 138a of the first top spacer feature 138. It will be appreciated that the first adjustable spacing dimension 160 may correspond to a plurality of spacing dimensions that vary in size depending on the location of the base component 110 relative to the top component 130 when it moves longitudinally relative to the base component 110.

According to still other embodiments, the first longitudinal edge 113 of the base component 110 may include a plurality of dimensional markings 122. According to particular embodiments, the plurality of dimensional markings 122 may correspond to the plurality of spacing dimensions that may be created between the outer edge 118a of the first base spacer feature 118 and the outer edge 138a of the first top spacer feature 138.

According to still other embodiments, the alignment tool may be configured so that when an inner edge 138b of the first top spacer feature 138 is lined up with a particular dimensional marking of the plurality of dimensional marking 122, the corresponding first adjustable spacing dimension 160 is created between the outer edge 118a of the first base spacer feature 118 and the outer edge 138a of the first top spacer feature 138.

According to yet other embodiments, the second base spacer feature 119 may extend out from the second longitudinal edge 114 of the base component 110. According to certain embodiments, the second base spacer feature 119 may extend out from the second longitudinal edge 114 at any desired location. According to yet other embodiments, the second base spacer feature 119 may extend out from the second longitudinal edge 114 at the front edge 115.

According to still other embodiments, the second top spacer feature 139 may extend out from the second longitudinal edge 134 of the top component 130. According to certain embodiments, the second top spacer feature 139 may extend out from the second longitudinal edge 134 at any desired location. According to yet other embodiments, the second top spacer feature 139 may extend out from the second longitudinal edge 134 at the front edge 135.

According to yet other embodiments, the top component 130 and the base component 110 may be configured so that a second adjustable spacing dimension 161 is created between an outer edge 119a of the second base spacer feature 119 and an outer edge 139a of the second top spacer feature 139. It will be appreciated that the second adjustable spacing dimension 161 may correspond to a plurality of spacing dimensions that vary in size depending on the location of the base component 110 relative to the top component 130 when it moves longitudinally relative to the base component 110.

According to still other embodiments, the second longitudinal edge 114 of the base component 110 may include a plurality of dimensional markings 123. According to particular embodiments, the plurality of dimensional markings 123 may correspond to the plurality of spacing dimensions that may be created between the outer edge 119a of the second base spacer feature 119 and the outer edge 139a of the second top spacer feature 139.

According to still other embodiments, the alignment tool may be configured so that when an inner edge 139b of the second top spacer feature 139 is lined up with a particular dimensional marking of the plurality of dimensional marking 123, the corresponding second adjustable spacing dimension 161 is created between the outer edge 119a of the second base spacer feature 119 and the outer edge 139a of the second top spacer feature 139.

According to still other embodiments, the alignment tool 100 may further include a locking mechanism 150 configured to fix the location of the top component 130 relative to the bottom component 110, thus fixing any spacing dimension created on the tool as described herein. It will be appreciated that the locking mechanism 150 may utilize any means that may fix the movement of the top component 130 relative to the bottom component 110.

Turning now to FIG. 1B, FIG. 1B shows a second schematic perspective view of the alignment tool 100 shown in FIG. 1A according to embodiments described herein. In particular, FIG. 1B shows a view of the opposite side of the alignment tool 100.

Turning now to FIG. 1C, FIG. 1C shows a schematic side view of the alignment tool 100 shown in FIGS. 1A and 1B according to embodiments described herein. In particular, FIG. 1C shows a view of the side of the alignment tool 100 shown in FIG. 1B.

Turning now to alternative embodiments of an alignment tool described herein, it will be appreciated that the alignment tool 100 (as described and shown in FIGS. 1A, 1B, and 1C) may further include additional spacer features.

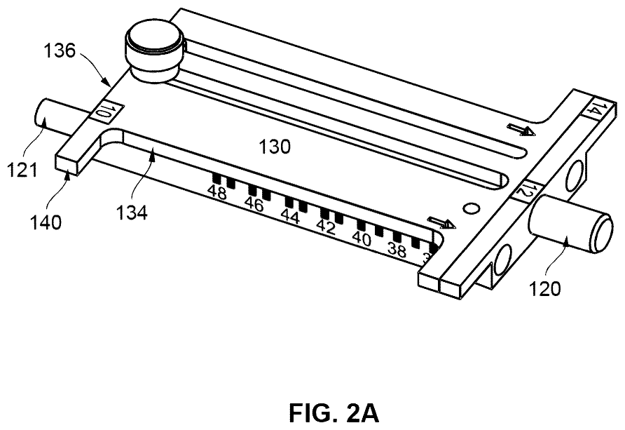

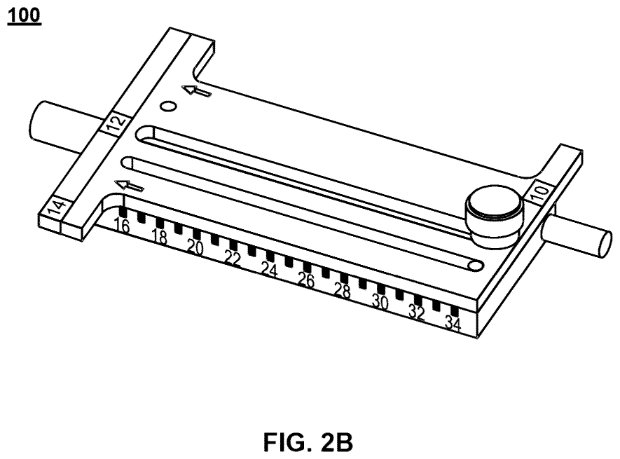

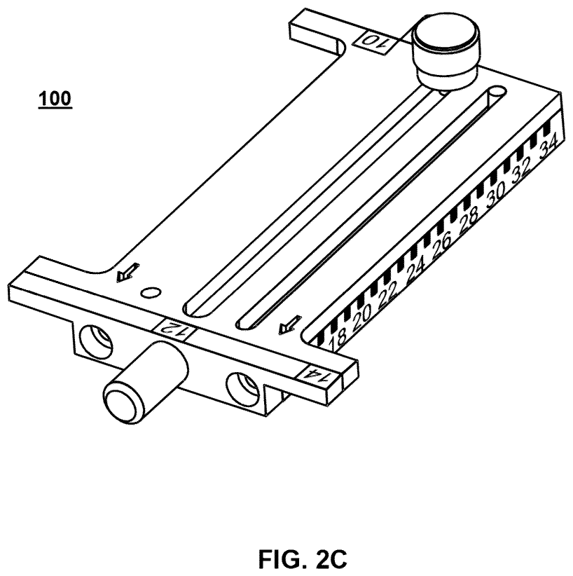

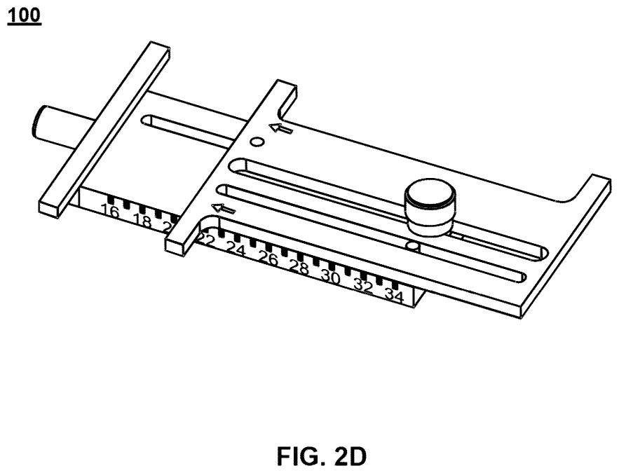

As shown in FIG. 2A, and according to still other embodiments, the top component 130 may further include a third top spacer feature 140. According to certain embodiments, the third top spacer feature 140 may extend out from the second longitudinal edge 134 of the top component 130. According to certain embodiments, the third top spacer feature 140 may extend out from the second longitudinal edge 134 at any desired location. According to yet other embodiments, the third top spacer feature 140 may extend out from the second longitudinal edge 134 at the back edge 136.

According to yet other embodiments, the top component 130 and the base component 110 may be configured so that a third adjustable spacing dimension 162 is created between an outer edge 119a of the second base spacer feature 119 and an outer edge 140a of the third top spacer feature 140. It will be appreciated that the third adjustable spacing dimension 162 may correspond to a plurality of spacing dimensions that vary in size depending on the location of the base component 110 relative to the top component 130 when it moves longitudinally relative to the base component 110.

According to still other embodiments, the second longitudinal edge 114 of the base component 110 may include a plurality of dimensional markings 124. According to particular embodiments, the plurality of dimensional markings 124 may correspond to the plurality of spacing dimensions that may be created between the outer edge 119a of the second base spacer feature 119 and the outer edge 140a of the third top spacer feature 140.

According to still other embodiments, the alignment tool may be configured so that when an inner edge 139b of the second top spacer feature 139 is lined up with a particular dimensional marking of the plurality of dimensional marking 124, the corresponding third adjustable spacing dimension 162 is created between the outer edge 119a of the second base spacer feature 119 and the outer edge 140a of the third top spacer feature 139.

According to still other embodiments, and as shown in FIG. 2A, the base component 110 may further include a third base spacer feature 120 extending out from the front edge 115. According to certain embodiments, the third base spacer feature 120 may have a set width. According to yet other embodiments, the set width may correspond to a particular spacing dimension 163.

According to still other embodiments, and as shown in FIG. 1A, the base component 110 may further include a fourth base spacer feature 121 extending out from the back edge 116. According to certain embodiments, the fourth base spacer feature 121 may have a set width. According to yet other embodiments, the set width may correspond to a particular spacing dimension 164.

Turning now to FIG. 2B, FIG. 2B shows a second schematic perspective view of the alignment tool 100 shown in FIG. 2A according to embodiments described herein. In particular, FIG. 2B shows a view of the opposite side of the alignment tool 100.

Turning now to FIG. 2C, FIG. 2C shows a third schematic perspective view of the alignment tool 100 shown in FIGS. 2A and 2B according to embodiments described herein. In particular, FIG. 2C shows a view of the front side of the alignment tool 100.

Turning now to FIG. 2D, FIG. 2D shows a schematic side view of the alignment tool 100 shown in FIGS. 2A, 2B and 2C according to embodiments described herein. In particular, FIG. 2D shows a view of the alignment tool 100 where the top component 130 has been slid longitudinally backward along the surface of the base component 110.

Turning now to a fibrous glass board duct cutting system, according to other embodiments, a fibrous glass board duct cutting system may include a fibrous glass board duct cutting apparatus, and an alignment tool according to embodiments described herein. According to certain embodiments, the fibrous glass board duct cutting apparatus may include a base, a mounting component, and a plurality of fibrous glass board cutting components attached to the mounting component.

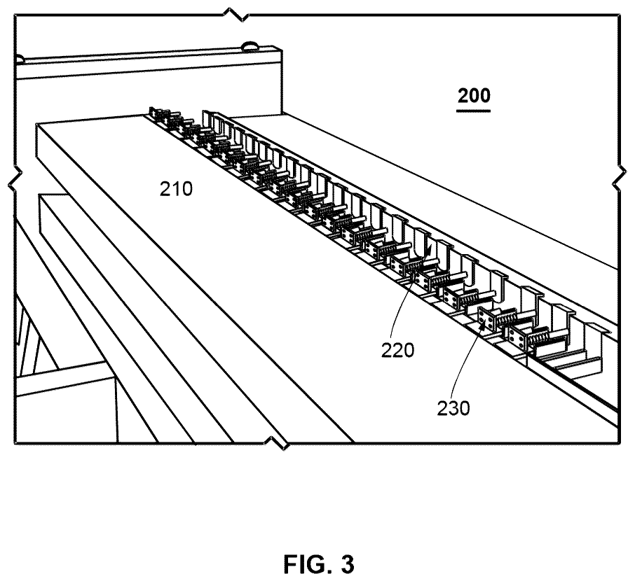

For purposes of illustration, FIG. 3 shows a fibrous glass board duct cutting apparatus 200 according to embodiments described herein. According to certain embodiments, the fibrous glass board duct cutting apparatus 200 may include a base 210, a mounting component 220, and a plurality of fibrous glass board cutting components 230 attached to the mounting component 220.

According to certain embodiments, the various spacing dimensions that can be created using the alignment tool 100 as described herein may be used to uniformly space the fibrous glass board cutting components 230 along the mounting component 230. For example, the alignment tool 100 may be adjusted to provide one of the spacing dimensions (i.e., spacing dimension 160, 161, 162, 163 or 164). Then, the portion of the alignment tool 100 providing the spacing dimension (i.e., for the spacing dimension 160, the outer edge 118a of the first base spacer feature 118 to the outer edge 138a of the first top spacer feature 138) may be placed in between each fibrous glass board cutting component 230 of the fibrous glass board duct cutting system 200. Finally, each fibrous glass board cutting component 230 may be secured in place along the mounting component 220 to ensure the uniform spacing of the fibrous glass board cutting components 230 is maintained.

It will be appreciated that the fibrous glass board cutting component 230 may be any desired cutting component that is configured to cut at least a portion of a fibrous glass board. According to certain embodiments, the cutting component may be a straight edged cutting component. According to still other embodiments, the cutting component may be a curved cutting component. According to yet other embodiments, the cutting component may be a groove-cutting component. According to still other embodiments, the groove-cutting component may have any desired shape configured to cut a desired groove shape into a fibrous glass board. For example, the groove-cutting component may have a shape configured to cut a v-shaped groove into a fibrous glass board. According to still other embodiments, the groove-cutting component may have a shape configured to cut a u-shaped groove into a fibrous glass board.

According to yet another aspect, a method of forming a fibrous glass board duct may include providing a fibrous glass board duct cutting system that may include a fibrous glass board duct cutting apparatus, and an alignment tool, providing a piece of uncut fibrous glass board material, using the alignment tool to configure the fibrous glass board duct cutting apparatus for cutting grooves into the uncut fibrous glass board material, cutting grooves into the piece of uncut fibrous glass board using the configured fibrous glass board cutting apparatus, and forming the cut piece of fibrous glass board in the fibrous glass board duct. The fibrous glass board duct cutting apparatus may include a base, a mounting component, and a plurality of fibrous glass board cutting components attached to the mounting component. The alignment tool may include a base component and a top component. The base component may have a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component. The top component may have a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component. The top component may be slidably mounted to the base component and configured so that a first adjustable spacing dimension is created between an outer edge of the first base spacer feature and an outer edge of the first top spacer feature. The spacing dimension may be configured to uniformly space the plurality of fibrous glass board cutting components along the mounting component of the fibrous glass board duct cutting apparatus. Using the alignment tool to configure the fibrous glass board duct cutting apparatus may include using the alignment tool to uniformly space the plurality of fibrous glass board cutting components along the mounting component of the fibrous glass board groove-cutting apparatus.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.
Embodiment 1. An alignment tool for aligning cutting components of a fibrous glass board duct cutting apparatus, wherein the alignment tool comprises: a base component having a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component, and a top component having a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component, wherein the top component is slidably mounted to the base component and configured so that a first adjustable spacing dimension is created between an outer edge of the first base spacer feature and an outer edge of the first top spacer feature.
Embodiment 2. The alignment tool of embodiment 1, wherein the first longitudinal edge of the base component comprises a plurality of dimensional markings corresponding to a plurality of spacing dimensions that can be created between the outer edge of the first base spacer feature and the outer edge of the first top spacer feature.
Embodiment 3. The alignment tool of embodiment 2, wherein the tool is configured so that the top component can be moved longitudinally along the top surface of the base component to align an inside edge of the first top spacer feature with one of the plurality of dimensional markings on the first longitudinal edge of the base component to separate the outer edge of the first base spacer feature and the outer edge of the first top spacer feature at the corresponding spacing dimension.
Embodiment 4. The alignment tool of embodiment 1, wherein the base component further comprises a second base spacer feature extending out from the second longitudinal edge of the base component at the front edge of the base component, and the top component further comprises a second top spacer feature extending out from the second longitudinal edge of the top component at the front edge of the top component.
Embodiment 5. The alignment tool of embodiment 4, wherein the top component is configured so that a second adjustable spacing dimension is created between an outer edge of the second base spacer feature and an outer edge of the second top spacer feature.
Embodiment 6. The alignment tool of embodiment 4, wherein the second longitudinal edge comprises a plurality of dimensional markings corresponding to a plurality of spacing dimensions that can be created between the outer edge of the second base spacer feature and the outer edge of the second top spacer feature.
Embodiment 7. The alignment tool of embodiment 6, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the second top spacer feature at the corresponding spacing dimension.
Embodiment 8. The alignment tool of embodiment 1, wherein the base component further comprises a second base spacer feature extending out from the second longitudinal edge of the base component at the front edge of the base component, and the top component further comprises a third top spacer feature extending out from the second longitudinal edge of the top component at the back edge of the top component.
Embodiment 9. The alignment tool of embodiment 4, wherein the top component is configured so that a second adjustable spacing dimension is created between an outer edge of the second base spacer feature and an outer edge of the third top spacer feature.
Embodiment 10. The alignment tool of embodiment 4, wherein the second longitudinal edge comprises a plurality of dimensional markings corresponding to a plurality of spacing dimensions that can be created between the outer edge of the second base spacer feature and the outer edge of the third top spacer feature.
Embodiment 11. The alignment tool of embodiment 6, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the third top spacer feature at the corresponding spacing dimension.
Embodiment 12. The alignment tool of embodiment 1, wherein the base component comprises a third base spacer feature having a set width that corresponds to a spacing dimension.
Embodiment 13. The alignment tool of embodiment 12, wherein the base component comprises a fourth base spacer feature having a set width that corresponds to a spacing dimension.
Embodiment 14. The alignment tool of embodiment 1, wherein the tool further comprises a locking component configured to fix or release the longitudinal position of the base component relative to the top component.
Embodiment 15. A fibrous glass board duct cutting system comprising a fibrous glass board duct cutting apparatus, and an alignment tool, wherein the fibrous glass board duct cutting apparatus comprises a base, a mounting component, and a plurality of fibrous glass board cutting components attached to the mounting component, and wherein the alignment tool comprises: a base component having a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component, and a top component having a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component, wherein the top component is slidably mounted to the base component and configured so that a first adjustable spacing dimension is created between an outer edge of the first base spacer feature and an outer edge of the first top spacer feature, wherein the spacing dimension is configured to uniformly space the plurality of fibrous glass board cutting components along the mounting component of the fibrous glass board duct cutting apparatus.
Embodiment 16. The system of embodiment 15, wherein the first longitudinal edge of the base component comprises a plurality of dimensional markings corresponding to a plurality of spacing dimensions that can be created between the outer edge of the first base spacer feature and the outer edge of the first top spacer feature.
Embodiment 17. The system of embodiment 16, wherein the tool is configured so that the top component can be moved longitudinally along the top surface of the base component to align an inside edge of the first top spacer feature with one of the plurality of dimensional markings on the first longitudinal edge of the base component to separate the outer edge of the first base spacer feature and the outer edge of the first top spacer feature at the corresponding spacing dimension.
Embodiment 18. The system of embodiment 15, wherein the base component further comprises a second base spacer feature extending out from the second longitudinal edge of the base component at the front edge of the base component, and the top component further comprises a second top spacer feature extending out from the second longitudinal edge of the top component at the front edge of the top component.
Embodiment 19. The system of embodiment 18, wherein the top component is configured so that a second adjustable spacing dimension is created between an outer edge of the second base spacer feature and an outer edge of the second top spacer feature.
Embodiment 20. The system of embodiment 18, wherein the second longitudinal edge comprises a plurality of dimensional markings corresponding to a plurality of spacing dimensions that can be created between the outer edge of the second base spacer feature and the outer edge of the second top spacer feature.
Embodiment 21. The system of embodiment 20, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the second top spacer feature at the corresponding spacing dimension.
Embodiment 22. The system of embodiment 15, wherein the base component further comprises a second base spacer feature extending out from the second longitudinal edge of the base component at the front edge of the base component, and the top component further comprises a third top spacer feature extending out from the second longitudinal edge of the top component at the back edge of the top component.
Embodiment 23. The system of embodiment 18, wherein the top component is configured so that a second adjustable spacing dimension is created between an outer edge of the second base spacer feature and an outer edge of the third top spacer feature.
Embodiment 24. The system of embodiment 18, wherein the second longitudinal edge comprises a plurality of dimensional markings corresponding to a plurality of spacing dimensions that can be created between the outer edge of the second base spacer feature and the outer edge of the third top spacer feature.
Embodiment 25. The system of embodiment 18, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the third top spacer feature at the corresponding spacing dimension.
Embodiment 26. The system of embodiment 15, wherein the base component comprises a third base spacer feature having a set width that corresponds to a spacing dimension.
Embodiment 27. The system of embodiment 12, wherein the base component comprises a fourth base spacer feature having a set width that corresponds to a spacing dimension.
Embodiment 28. The system of embodiment 15, wherein the tool further comprises a locking component configured to fix or release the longitudinal position of the base component relative to the top component.
Embodiment 29. A method of configuring a fibrous glass board duct cutting system, wherein the method comprises: providing a fibrous glass board duct cutting apparatus comprising a fibrous glass board duct cutting apparatus, and an alignment tool, wherein the fibrous glass board duct cutting apparatus comprises a base, a mounting component, and a plurality of fibrous glass board cutting components attached to the mounting component, and using the alignment tool to uniformly space the plurality of fibrous glass board cutting components along the mounting component of the fibrous glass board groove-cutting apparatus, wherein the alignment tool comprises: a base component having a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component, and a top component having a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component, wherein the top component is slidably mounted to the base component and configured so that a first adjustable spacing dimension is created between an outer edge of the first base spacer feature and an outer edge of the first top spacer feature, wherein the spacing dimension is configured to uniformly space the plurality of fibrous glass board cutting components along the mounting component of the fibrous glass board duct cutting apparatus.
Embodiment 30. The method of embodiment 29, wherein the first longitudinal edge of the base component comprises a plurality of dimensional markings corresponding to a plurality of spacing dimensions that can be created between the outer edge of the first base spacer feature and the outer edge of the first top spacer feature.
Embodiment 31. The method of embodiment 30, wherein the tool is configured so that the top component can be moved longitudinally along the top surface of the base component to align an inside edge of the first top spacer feature with one of the plurality of dimensional markings on the first longitudinal edge of the base component to separate the outer edge of the first base spacer feature and the outer edge of the first top spacer feature at the corresponding spacing dimension.
Embodiment 32. The method of embodiment 29, wherein the base component further comprises a second base spacer feature extending out from the second longitudinal edge of the base component at the front edge of the base component, and the top component further comprises a second top spacer feature extending out from the second longitudinal edge of the top component at the front edge of the top component.
Embodiment 33. The method of embodiment 32, wherein the top component is configured so that a second adjustable spacing dimension is created between an outer edge of the second base spacer feature and an outer edge of the second top spacer feature.
Embodiment 34. The method of embodiment 32, wherein the second longitudinal edge comprises a plurality of dimensional markings corresponding to a plurality of spacing dimensions that can be created between the outer edge of the second base spacer feature and the outer edge of the second top spacer feature.
Embodiment 35. The method of embodiment 32, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the second top spacer feature at the corresponding spacing dimension.
Embodiment 36. The method of embodiment 29, wherein the base component further comprises a second base spacer feature extending out from the second longitudinal edge of the base component at the front edge of the base component, and the top component further comprises a third top spacer feature extending out from the second longitudinal edge of the top component at the back edge of the top component.
Embodiment 37. The method of embodiment 32, wherein the top component is configured so that a second adjustable spacing dimension is created between an outer edge of the second base spacer feature and an outer edge of the third top spacer feature.
Embodiment 38. The method of embodiment 32, wherein the second longitudinal edge comprises a plurality of dimensional markings corresponding to a plurality of spacing dimensions that can be created between the outer edge of the second base spacer feature and the outer edge of the third top spacer feature.
Embodiment 39. The method of embodiment 38, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the third top spacer feature at the corresponding spacing dimension.
Embodiment 40. The method of embodiment 29, wherein the base component comprises a third base spacer feature having a set width that corresponds to a spacing dimension.
Embodiment 41. The method of embodiment 40, wherein the base component comprises a fourth base spacer feature having a set width that corresponds to a spacing dimension.
Embodiment 42. The method of embodiment 29, wherein the tool further comprises a locking component configured to fix or release the longitudinal position of the base component relative to the top component.

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An alignment tool for aligning cutting components of a fibrous glass board duct cutting apparatus, wherein the alignment tool comprises:
a base component having a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component, and
a top component having a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component,
wherein the top component is slidably mounted to the base component and configured so that a first adjustable spacing dimension is created between an outer edge of the first base spacer feature and an outer edge of the first top spacer feature.

2. The alignment tool of claim 1, wherein the first longitudinal edge of the base component comprises a plurality of dimensional markings corresponding to a plurality of spacing dimensions that can be created between the outer edge of the first base spacer feature and the outer edge of the first top spacer feature.

3. The alignment tool of claim 2, wherein the tool is configured so that the top component can be moved longitudinally along the top surface of the base component to align an inside edge of the first top spacer feature with one of the plurality of dimensional markings on the first longitudinal edge of the base component to separate the outer edge of the first base spacer feature and the outer edge of the first top spacer feature at the corresponding spacing dimension.

4. The alignment tool of claim 1, wherein the base component further comprises a second base spacer feature extending out from the second longitudinal edge of the base component at the front edge of the base component, and the top component further comprises a second top spacer feature extending out from the second longitudinal edge of the top component at the front edge of the top component.

5. The alignment tool of claim 4, wherein the top component is configured so that a second adjustable spacing dimension is created between an outer edge of the second base spacer feature and an outer edge of the second top spacer feature.

6. The alignment tool of claim 4, wherein the second longitudinal edge comprises a plurality of dimensional markings corresponding to a plurality of spacing dimensions that can be created between the outer edge of the second base spacer feature and the outer edge of the second top spacer feature.

7. The alignment tool of claim 6, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the second top spacer feature at the corresponding spacing dimension.

8. The alignment tool of claim 1, wherein the base component further comprises a second base spacer feature extending out from the second longitudinal edge of the base component at the front edge of the base component, and the top component further comprises a third top spacer feature extending out from the second longitudinal edge of the top component at the back edge of the top component.

9. The alignment tool of claim 8, wherein the top component is configured so that a second adjustable spacing dimension is created between an outer edge of the second base spacer feature and an outer edge of the third top spacer feature.

10. The alignment tool of claim 8, wherein the second longitudinal edge comprises a plurality of dimensional markings corresponding to a plurality of spacing dimensions that can be created between the outer edge of the second base spacer feature and the outer edge of the third top spacer feature.

11. The alignment tool of claim 8, wherein the tool is configured so that the top component can be moved longitudinally along the top surface of the base component to align an inside edge of the second top spacer feature with one of the plurality of dimensional markings on the second longitudinal edge to separate the outer edge of the second base spacer feature and the outer edge of the third top spacer feature at the corresponding spacing dimension.

12. The alignment tool of claim 1, wherein the base component comprises a third base spacer feature having a set width that corresponds to a spacing dimension.

13. The alignment tool of claim 12, wherein the base component comprises a fourth base spacer feature having a set width that corresponds to a spacing dimension.

14. The alignment tool of claim 1, wherein the tool further comprises a locking component configured to fix or release the longitudinal position of the base component relative to the top component.

15. A fibrous glass board duct cutting system comprising a fibrous glass board duct cutting apparatus, and an alignment tool,
wherein the fibrous glass board duct cutting apparatus comprises a base, a mounting component, and a plurality of fibrous glass board cutting components attached to the mounting component, and
wherein the alignment tool comprises:
a base component having a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component, and
a top component having a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component,
wherein the top component is slidably mounted to the base component and configured so that a first adjustable spacing dimension is created between an outer edge of the first base spacer feature and an outer edge of the first top spacer feature,
wherein the spacing dimension is configured to uniformly space the plurality of fibrous glass board cutting components along the mounting component of the fibrous glass board duct cutting apparatus.

16. The system of claim 15, wherein the first longitudinal edge of the base component comprises a plurality of dimensional markings corresponding to a plurality of spacing dimensions that can be created between the outer edge of the first base spacer feature and the outer edge of the first top spacer feature.

17. The system of claim 16, wherein the tool is configured so that the top component can be moved longitudinally along the top surface of the base component to align an inside edge of the first top spacer feature with one of the plurality of dimensional markings on the first longitudinal edge of the base component to separate the outer edge of the first base spacer feature and the outer edge of the first top spacer feature at the corresponding spacing dimension.

18. The system of claim 15, wherein the base component further comprises a second base spacer feature extending out from the second longitudinal edge of the base component at the front edge of the base component, and the top component further comprises a second top spacer feature extending out from the second longitudinal edge of the top component at the front edge of the top component.

19. The system of claim 18, wherein the top component is configured so that a second adjustable spacing dimension is created between an outer edge of the second base spacer feature and an outer edge of the second top spacer feature.

20. A method of configuring a fibrous glass board duct cutting system, wherein the method comprises:
providing a fibrous glass board duct cutting apparatus comprising a fibrous glass board duct cutting apparatus, and an alignment tool, wherein the fibrous glass board duct cutting apparatus comprises a base, a mounting component, and a plurality of fibrous glass board cutting components attached to the mounting component, and
using the alignment tool to uniformly space the plurality of fibrous glass board cutting components along the mounting component of the fibrous glass board groove-cutting apparatus:
wherein the alignment tool comprises:
a base component having a top surface, a bottom surface opposite of the top surface, a first longitudinal edge, a second longitudinal edge opposite of the first longitudinal edge, a front edge, a back edge opposite of the front edge, a stopper ridge extending up from the top surface of the base component at the front edge of the base component and a first base spacer feature extending out from the first longitudinal edge of the base component at the front edge of the base component, and
a top component having a top surface, a bottom surface opposite of the top surface, a first longitudinal edge, a second longitudinal edge opposite of the first longitudinal edge, a front edge, a back edge opposite of the front edge, and a first top spacer feature extending out from the first longitudinal edge of the top component at the front edge of the top component,
wherein the top component is slidably mounted to the base component and configured so that a first adjustable spacing dimension is created between an outer edge of the first base spacer feature and an outer edge of the first top spacer feature,
wherein the spacing dimension is configured to uniformly space the plurality of fibrous glass board cutting components along the mounting component of the fibrous glass board duct cutting apparatus.
